(19) United States
(12) Patent Application Publication
(10) Pub. No.: US 2008/0077959 A1
(43) Pub. Date: Mar. 27, 2008

(54) Broadcast Receiving Apparatus and Broadcast Receiving Method

(76) Inventors: Masayuki Kirimura, Tokyo (JP); Naoki Shimizu, Tokyo (JP); Masashi Saito, Tokyo (JP)

Correspondence Address: BIRCH STEWART KOLASCH & BIRCH, PO BOX 747, FALLS CHURCH, VA, 22040-0747, US

(21) Appl. No.: 11/632,527

(22) PCT Filed: Aug. 2, 2004
(86) PCT No.: PCT/JP04/11040

§ 371 Date: Jan. 17, 2007

(51) Int. Cl. H04N 5/44

(52) U.S. Cl. 725/46

(57) ABSTRACT

A broadcast receiving apparatus A0 selects a scene which a user prefers from a plurality of broadcast programs being broadcasted. A broadcast data acquiring part A2 acquires broadcast data of each broadcast program in the same time period, based on a schedule stored in a monitoring schedule storing part A4. A preference information monitoring part A6 compare the broadcast data acquired by the broadcast data acquiring part A2 with preference information stored in a preference information storing part A5, and judges whether the broadcast program indicated by the compared broadcast data accords with the preference information of the user. A record processing part A72 records the broadcast data judged to be in accord with the user's preference information.

### TECHNICAL FIELD

The present invention relates to a broadcast receiving apparatus and a broadcast receiving method that perform user supporting by automatically and real-timely recording, displaying, etc. scenes which a user prefers, from a plurality of channels in broadcast environment of a plurality of channels repeatedly executed at random.

### BACKGROUND ART

With the multichannel orientation of television broadcasting and the Internet broadcasting, a user support technology that real-timely provides recording a scene which a user prefers, switching a display to a scene which a user prefers, etc. from a plurality of channels is desired.

The Patent Document 1 discloses service of real-timely performing recording when a voice corresponding to a preference keyword is uttered in television broadcasting, in a single channel.

The Patent Documents 2, 3, and 4 disclose a method of checking a degree of correspondence between a program table and a preference keyword in advance and recording programs satisfying the correspondence, in digital broadcasting.

The patent Document 5 discloses a method of setting a response server, creating a program table for each registered individual, investigating a degree of correspondence between the program table and a preference keyword beforehand, and recording a program satisfying the correspondence.

However, as each of these references takes into consideration the degree of correspondence between the program table and preference information, it cannot react to the case of information not in a program table, or program content added for the first time with a program image during broadcasting, such as the case of a live broadcast. Moreover, the number of channels monitored in real time is a single channel and a concrete technique of monitoring a plurality of channels is not described.

Patent Document 1: Japanese Non-examined Patent Publication No. 9-252451

Patent Document 2: Japanese Non-examined Patent Publication No. 2001-134998

Patent Document 3: Japanese Non-examined Patent Publication No. 7-212327

Patent Document 4: Japanese Non-examined Patent Publication No. 2002-217761

Patent Document 5: Japanese Non-examined Patent Publication No. 2001-326925

### DISCLOSURE OF THE INVENTION

Problems to be Solved by the Invention

For the reasons mentioned above, when recording and displaying a scene which a user prefers from broadcast data of a plurality of channels repeatedly executed at random, it is necessary to change channels in order by a remote control operation etc., to search the scene which the user prefers, and to perform recording and displaying by the user himself/herself.

It is one of objects of the present invention to solve the problems stated above and to achieve recording and displaying a scene which a user prefers, without performing operations for changing channels, and for searching, recording and displaying the scene which the user prefers, with respect to broadcast data of a plurality of channels repeatedly executed at random.

Means to Solve the Problems

According to a broadcast receiving apparatus of the present invention, the broadcast receiving apparatus includes:

a preference information storing part to store preference information;

a monitoring schedule storing part to store a monitoring schedule table that indicates a monitoring schedule for each broadcast program in the same time period;

a broadcast data acquiring part to acquire broadcast data relating to a broadcast program; and

a preference information monitoring part to judge whether a broadcast program being currently monitored is in accord with the preference information,

wherein the broadcast data acquiring part acquires the broadcast data of each broadcast program in the same time period, based on the monitoring schedule table stored in the monitoring schedule storing part, and

the preference information monitoring part compares the broadcast data acquired by the broadcast data acquiring part with the preference information stored in the preference information storing part, and judges whether the broadcast program indicated by a compared broadcast data accords with the preference information.

The broadcast receiving apparatus further includes:

a program table storing part to store a program table being data that indicates broadcast content of each broadcast program in each time period;

a program priority storing part to store a program priority table that indicates a priority of a broadcast program for acquiring broadcast data; and

a broadcast acquisition scheduling part to generate the monitoring schedule table,

wherein the broadcast data acquiring part acquires a program table as broadcast data, and stores an acquired program table in the program table storing part, and

the broadcast acquisition scheduling part compares the broadcast content of each broadcast program in each time period indicated by the program table stored in the program table storing part with the preference information stored in the preference information storing part, judges priority of each broadcast program in each time period to be corresponding to the preference information, generates a program priority table based on a judged priority, stores a generated program priority table in the program priority storing part, generates a monitoring schedule table by determining a monitoring schedule for each broadcast program in each time period, based on the program priority table stored in the program priority storing part, and stores a generated monitoring schedule table in the monitoring schedule storing part.

The broadcast acquisition scheduling part determines a monitoring schedule by making at least one of continuous monitoring time and monitoring frequency be corresponding to the priority of the each broadcast program indicated by the program priority table stored in the program priority storing part.

The broadcast receiving apparatus further includes:

an event execution part to execute various types of events, which has an event processing part, and an event control part to control the event processing part,

wherein the event processing part includes at least one of

a record processing part to record broadcast data;

a display switching processing part to switch broadcast data to display;

a sound notice processing part to perform noticing by sound;

a display effect processing part to display display data; and

a mail processing part to transmit a mail, and

the event processing part is executed with respect to the broadcast program, judged by the preference information monitoring part, to be in accord with preference information.

The broadcast data acquiring part compares the broadcast data being currently acquired with the broadcast data having already been acquired, and when it is judged that a degree of correspondence is high, switches the broadcast program for acquiring broadcast data to a broadcast program scheduled to be next in the monitoring schedule table.

A plurality of the broadcast data acquiring parts is provided.

Each of the plurality of broadcast data acquiring parts acquires broadcast data of a different broadcast program in the same time period with respect to all broadcast programs, based on the monitoring schedule table.

Each of the plurality of broadcast data acquiring parts acquires broadcast data of a different broadcast program in the same time period with respect to one or more than one broadcast programs differing from each other, based on the monitoring schedule table.

At least one broadcast data acquiring part in the plurality of broadcast data acquiring parts acquires broadcast data of the broadcast program, judged by the preference information monitoring part, to be in accord with preference information, and other broadcast data acquiring parts acquire broadcast data of different broadcast programs in the same time period based on the monitoring schedule table.

The broadcast data includes text data relating to a broadcast program, and the preference information monitoring part performs judgment processing, based on the text data included in the broadcast data acquired by the broadcast data acquiring part and the preference information stored in the preference information storing part.

The broadcast data includes at least one of sound data and image data relating to a broadcast program,

the broadcast receiving apparatus further includes at least one of a sound data identifying part to identify the sound data included in the broadcast data acquired by the broadcast data acquiring part and to convert it into corresponding text data, and an image data identifying part to identify the image data included in the broadcast data acquired by the broadcast data acquiring part and to convert it into corresponding text data, and

the preference information monitoring part performs judgment processing, based on the preference information stored in the preference information storing part and at least one of the text data converted from sound data by the sound data identifying part and image data converted from image data by the image data identifying part.

According to a broadcast receiving method of a broadcast receiving apparatus of the present invention, the broadcast receiving method includes:

storing preference information;

storing a monitoring schedule table that indicates a monitoring schedule for each broadcast program in the same time period;

acquiring broadcast data relating to a broadcast program; and

judging whether the broadcast program being currently monitored is in accord with the preference information;

acquiring the broadcast data of the each broadcast program in the same time period, based on the monitoring schedule table stored;

comparing the broadcast data acquired with the preference information stored; and

judging whether the broadcast program indicated by a compared broadcast data accords with the preference information.

Effects of the Invention

In accordance with the present invention, it is possible to achieve recording, displaying, etc. a scene which a user prefers, without performing operations for changing channels, and for searching, recording and displaying the scene which the user prefers, with respect to broadcast data of a plurality of channels repeatedly executed at random, which enhances the user's convenience.

### PREFERRED EMBODIMENTS FOR CARRYING OUT THE INVENTION

### Embodiment 1

FIG. 1 shows a hardware configuration of a broadcast receiving apparatus A0 described in Embodiment 1. The broadcast receiving apparatus A0 can be formed as a television, a video, a personal computer, a portable information terminal, etc. Then, a cellular phone, a PDA (Personal Digital Assistance), etc. can be the portable information terminal. As shown in FIG. 1, the broadcast receiving apparatus A0 includes a CPU (Central Processing Unit) 911 that executes a program. The CPU 911 is connected with a ROM 913, a RAM 914, a communication board 915, a display device 901, and a magnetic disk drive 920, through a bus 912. Furthermore, it may be connected with a keyboard (K/B), a mouse, a touch panel, a FDD (Flexible Disk Drive), a compact disk drive (CDD), a printer, a scanner, etc. Some of the display device 901 is a type utilizing a cathode-ray tube or a liquid crystal. The RAM 914 is an example of a volatile memory. The ROM 913, the FDD, the CDD, the magnetic disk drive 920, and an optical disc device are examples of a nonvolatile memory. These are examples of a storage device or a storing part. The communication board 915 is connected to a facsimile machine, a telephone, a LAN, the Internet, etc. For example, the communication board 915, the K/B, the touch panel, the scanner, the FDD, etc. are examples of an input part. Moreover, for example, the communication board 915, the display device 901, etc. are examples of an output part.

In the magnetic disk drive 920, an operating system (OS) 921, a program group 923, and a file group 924 are stored. Furthermore, a window system etc. may be stored. The program group 923 is executed by the CPU 911, the OS 921, and the window system.

In the program group 923, programs that execute functions expressed as “part” in the description of the following Embodiments are stored. The programs are read and executed by the CPU 911. In the file group 924, what is expressed as a “judgment result of —”, a “calculation result of —”, or a “processing result of —” in the explanation of Embodiments described below is stored as a “file”. Moreover, arrows in flowcharts for explaining Embodiments described below mainly show inputting/outputting of data. Then, for performing the inputting/outputting of data, the data is stored on a recording medium, such as the magnetic disk drive 920, a FD (Flexible Disk cartridge), an optical disc, a CD (compact disk), a MD (mini disc), and a DVD (Digital Versatile Disk). Alternatively, the data is transmitted by a signal line or other transmission medium.

Moreover, what is expressed as a “part” in Embodiments described below may be achieved by firmware stored in the ROM 913. Otherwise, it maybe executed by only software, by only hardware, by combination of software and hardware, or further by combination with firmware.

Moreover, programs that execute Embodiments described below may be stored in a recording device of other storage medium, such as the magnetic disk drive 920, an FD, an optical disc, a CD, an MD, and a DVD.

FIG. 2 shows a whole configuration of the broadcast receiving apparatus A0 described in Embodiment 1. In FIG. 2, a broadcast receiving part A1 is a module for receiving broadcast data contained in a broadcasted television signal, and is, for example, an antenna in TV broadcasting service, or an Ethernet (registered trademark) card for a personal computer.

A broadcast data acquiring part A2 acquires broadcast data on a broadcast program, using the broadcast receiving part A1. The broadcast data includes program images, program sound, character information of programs, and in addition, each data of a program table indicating broadcast contents of each broadcast program in each time period.

A monitoring schedule generating part A3 includes a broadcast acquisition scheduling part A31, a program priority storing part A32 to store a program priority table A321, and a program table storing part A33 to store a program table A331. In order to preferentially acquire a program having a high probability of including information which a user prefers, by using the program table A331 and preference information A51, the broadcast acquisition scheduling part A31 is configured as a module that schedules orders of programs monitored by the broadcast data acquiring part A2, to generate a monitoring schedule table A41.

A monitoring schedule storing part A4 is a module for storing the monitoring schedule table A41 generated by the broadcast acquisition scheduling part A31 in an internal storage, such as a memory.

The program table storing part A33 is a module for storing the program table A331 acquired by the broadcast data acquiring part A2, in an internal storage, such as a memory.

A program content storing part A9 is a module for storing information on broadcast data acquired by the broadcast data acquiring part A2, such as text data of character information explaining a program, in an internal storage, for example a memory. Hereafter, data stored in the program content storing part A9 and used for judging whether a broadcast program concerned accords with user's taste or not is defined as content data.

A preference information storing part A5 is a module for storing preference information in which user's taste is kept as a keyword, in an internal storage, such as a memory. A preference information input part A8 is a module for storing data, such as a keyword relating to taste, which a user inputs, in the preference information storing part A5.

A preference information monitoring part A6 is a module for searching content data acquired by the broadcast data acquiring part A2 and stored in the program content storing part A9, to find whether some in the searched content data accords with data, such as a keyword, in the preference information A51 stored in the preference information storing part A5 or not.

An event execution part A7 includes an event control part A71 that controls processing of events executed by the event execution part A7, and an event processing part A79 that processes the events. Moreover, the event processing part A79 includes a record processing part A72 that has a function of recording broadcast data of a broadcast program. The event control part A71 is a module for transmitting a signal for executing the record processing part A72 when the preference information monitoring part A6 judges that a broadcast program indicated by the broadcast data acquired by the broadcast data acquiring part A2 accords with user's preference information.

The record processing part A72 is a module for performing recording operations: recording images, recording sound, storing, etc. of a program image, a program sound, etc.

FIG. 3 shows a broadcast program described in Embodiment 1. In FIG. 3, a program image B3 is an image of a television or a stream picture of the Internet. A program sound B4 is sound of a television, stream sound of the Internet, sound of a radio, etc. The sound herein indicates not only voice but sound in general. A text B2 is supplementary information which explains the program image B3 and the program sound B4 to be broadcasted, or it may be independent character information. The program image B3, the program sound B4, and the text B2 are data included in the broadcast data acquired by the broadcast data acquiring part A2, and are output from the display device 901.

FIG. 4 shows the program table A331 stored in the program table storing part A33 described in Embodiment 1. In FIG. 4, with respect to each broadcast program identified by an identifier, such as a program 1, a program 2, and a program 3, the program table A331 stores a broadcast station, a program name, broadcast starting time, broadcast ending time, genre of a program content, program content for explaining the program briefly, and a performer of a program. The “broadcast station” is for identifying a side performing broadcasting, such as a television station name, a distribution company name, and a distributor name. The “genre” signifies a genre of the program, such as a baseball, a variety, news, music, and an animation. Furthermore, the program table A331 may also include a broadcast schedule in each broadcast program. For example, it is acceptable to divide the broadcasting hours from 18:55 to 20:55 of the broadcast program 1 into air time of commercials and appearance time of each performer, to be shown in the program table A331. Moreover, the program table A331 may not be the same as what is described above.

FIGS. 5 and 6 show the user's preference information A51 stored in the preference information storing part A5 described in Embodiment 1. In FIG. 5, the preference information A51 signifies keywords representing user's taste and genres to which the keywords belong. As the keyword, a proper noun, such as a performer's name, an action noun, such as “shoot” and “goal”, and a common noun, such as “ramen noodles” and “soccer” are stored. For example, if a user prefers soccer, the keyword of “soccer” or if the user desires to watch a shooting scene, the keyword of “shoot” is input through the preference information input part A8, and then, the preference information input part A8 stores the inputted keyword as character information in the preference information A51 in the preference information storing part A5. The“genre“is baseball, variety, news, music, animation, etc. A genre is input with a keyword by the user into the preference information input part A8 and the inputted genre may be stored in the preference information A51 in the preference information storing part A5. The preference information input part A8 judges the genre based on the keyword inputted by the user, and may store the judged genre in the preference information A51 in the preference information storing part A5. As shown in FIG. 6, priority of preference information for a keyword and a genre may be stored in the preference information A51, in addition to the keyword and the genre. Moreover, with regard to the priority, it maybe input by a user and stored, or it maybe judged by the preference information input part A8 and stored, like a genre. For example, it is acceptable to make a priority become high in accordance with an order of inputting. The preference information A51 may not be the same as what is described above.

FIGS. 7 and 8 show the program priority table A321 stored in the program priority storing part A32 described in Embodiment 1. In FIG. 7, the program priority table A321 is data where the broadcast acquisition scheduling part A31 judges a priority of each broadcast program being currently broadcasted, based on the program table A331 stored in the program table storing part A33 and the preference information A51 stored in the preference information storing part AS, and the broadcast acquisition scheduling part A31 stores the judgment result in the program priority storing part A32.

For example, when generating the program priority table A321 at 7:00, the broadcast acquisition scheduling part A31 judges priorities of programs to be broadcasted during the time period from 7:00 to 8:00. The broadcast acquisition scheduling part A31 makes the priority high with respect to a program with high possibility of having information preferred by the user, and makes the priority low with respect to a program with low possibility of having information preferred by the user, in the broadcast programs being currently broadcasted in one period of time. In the case of n programs being broadcasted in the same time period, the order of priorities from the first to the n-th is stored for each of the programs. Moreover, as shown in FIG. 8, a numerical value indicating a priority may be stored in addition to the order of priority of each broadcast program.

It is also acceptable to store a priority of each broadcast program at each time period in all the time periods whose schedules of broadcast programs are shown in the program table A331, in addition to the priority of each broadcast program at the time period when the program priority table A321 judges priorities. Moreover, the program priority table A321 may not be the same as what is described above.

FIGS. 9, 10, and 11 show the monitoring schedule table A41 stored in the monitoring schedule storing part A4 described in Embodiment 1. In FIGS. 9, 10, and 11, the monitoring schedule table A41 is data where the broadcast acquisition scheduling part A31 determines a monitoring schedule of each broadcast program being currently broadcasted, based on the program priority table A321 stored in the program priority storing part A32, and the broadcast acquisition scheduling part A31 stores the determination result in the monitoring schedule storing part A4.

In FIG. 9, the monitoring schedule table A41 stores continuous monitoring time for each broadcast program. For example, the broadcast data acquiring part A2 repeats the following: monitoring the broadcast program 2 for 300 consecutive seconds, stopping the monitoring of the broadcast program 2, monitoring the broadcast program 3 for 120 consecutive seconds, stopping the monitor of the broadcast program 3, and monitoring the broadcast program 1 for 45 consecutive seconds.

The broadcast acquisition scheduling part A31 lengthens continuous monitoring time for a program with a high priority indicated by the program priority table A321, shortens continuous monitoring time for a program with a low priority, and stores them in the monitoring schedule table A41. It is also acceptable to define fixed continuous monitoring time with respect to the order of priorities, or to define continuous monitoring time corresponding to a numerical value of the priority shown in FIG. 8.

In FIG. 10, the monitoring schedule table A41 stores a range of a random number, as monitoring frequency for each broadcast program. For example, the broadcast data acquiring part A2 includes a random number part (not shown) which generates integers from 1 to 100. If a random number generated by the random number part is an integer between 1 and 40, the broadcast program 2 is to be monitored for predetermined time, if the random number is an integer between 41 and 60, the broadcast program 3 is to be monitored for predetermined time, and if the random number is an integer between 61 and 75, the broadcast program 1 is to be monitored for predetermined time.

The broadcast acquisition scheduling part A31 widens the range of a random number with respect to a program with a high priority indicated by the program priority table A321, narrows the range of a random number with respect to a program with a low priority, and stores them in the monitoring schedule table A41. It is also acceptable to define a fixed random number range in accordance with the priority order, or to define a range of a random number corresponding to a numerical value of the priority shown in FIG. 8.

In FIG. 11, the monitoring schedule table A41 stores continuous monitoring time and monitoring frequency for each broadcast program. The broadcast acquisition scheduling part A31 lengthens the continuous monitoring time of a program with a high priority indicated by the program priority table A321, widens the range of a random number, and stores them in the monitoring schedule table A41. The broadcast acquisition scheduling part A31 shortens the continuous monitoring time of a broadcast program with a low priority, narrows the range of a random number, and stores them in the monitoring schedule table A41. It is also acceptable to define fixed continuous monitoring time and a fixed random number range in accordance with a priority order, or to define fixed continuous monitoring time and a fixed random number range corresponding to a numerical value of priority shown in FIG. 8.

By generating the monitoring schedule table A41 as mentioned above, the total of monitoring time of a broadcast program with a high priority becomes long, and the total of monitoring time of a broadcast program with a low priority becomes short. For this reason, it is possible to perform scheduling to easily acquire images, sound, and contents of a user's taste, which increases probability of acquiring a scene of the user's taste in a program with a high priority.

Moreover, the monitoring schedule table A41 may not be the same as what is described above.

FIG. 12 is a flowchart showing processing of the broadcast acquisition scheduling part A31 described in Embodiment 1. In FIG. 12, the broadcast acquisition scheduling part A31 generates the program priority table A321 to be stored in the program priority storing part A32, by performing processing from T1 to T5. Then, the broadcast acquisition scheduling part A31 generates the monitoring schedule table A41 to be stored in the monitoring schedule storing part A4, by performing processing T6s.

First, program data of each broadcast program is acquired from the program table A331 stored in the program table storing part A33. The program data herein is, for example, an identifier, a broadcast station, a program name, broadcast starting time, broadcast ending time, a genre, program content, and a performer shown in FIG. 4 (T1).

The acquired program data is compared with a keyword and a genre in the preference information A51 stored in the preference information storing part A5 (T2).

When the keyword and the genre in the preference information A51 are included in the compared program data, it is judged that the broadcast program indicated by the compared program data accords with the preference information A51 and has a high possibility of being a broadcast program which the user prefers (T3).

When it is judged that there is a high possibility of being a broadcast program which the user prefers, the priority of the broadcast program is set to be high in the program priority table A321 stored in the program priority storing part A32. It is also acceptable to set the priority to be high in proportion to the number of keywords and genres being in accord, or to set the priority to be high corresponding to a priority of preference information for the keyword and the genre shown in FIG. 6 (T4).

When it is not judged that there is a high possibility of being a broadcast program which the user prefers, the priority of the broadcast program is set to be low in the program priority table A321 stored in the program priority storing part A32. For example, the priority is set to be the lowest ranking or the value of the priority shown in FIG. 8 is set as 0 (T5).

After setting the priority of a broadcast program, it is judged whether program data of other broadcast program exists in the program table A331 or not, and if there is program data of other broadcast program, the following processing (T1-T5) is repeated (T6): acquiring program data of other broadcast program, and setting a priority based on the acquired program data.

When there is no program data of other broadcast program, the monitoring schedule table A41 is generated based on the program priority table A321 stored in the program priority storing part A32, and is stored in the monitoring schedule storing part A4.

The method of generating the monitoring schedule table A41 based on the program priority table A321 has already been explained with reference to FIGS. 9, 10, and 11 (T7).

FIG. 13 is a flowchart showing processing of the broadcast receiving apparatus A0 described in Embodiment 1. The flow of processing of the broadcast receiving apparatus A0 according to Embodiment 1 will be explained with reference to FIG. 13.

First, the broadcast data acquiring part A2 acquires the program table A331 from the broadcast receiving part A1, and stores the acquired program table A331 in the program table storing part A33 (S1).

Next, the broadcast acquisition scheduling part A31 performs acquisition scheduling of broadcast data, using the program table A331 stored in the program table storing part A33 and the preference information A51 stored in the preference information storing part A5, generates the monitoring schedule table A41, and stores the monitoring schedule table A41 in the monitoring schedule storing part A4 (S2). In the monitoring schedule table A41, the order of programs to monitor is scheduled based on time adjustment and frequency adjustment so that a program with a high probability of broadcasting user's preference information can be acquired preferentially. The flow of this processing has been described with reference to FIG. 12.

Next, the broadcast data acquiring part A2 acquires the monitoring schedule table A41 from the monitoring schedule storing part A4 (S3).

Then, the broadcast data acquiring part A2 acquires broadcast data of a broadcast program in accordance with a schedule of the monitoring schedule table A41 (S4). Program content, such as text data, is acquired from the broadcast data and stored in the program content storing part A9. If the program content acquired based on the scheduled time is in mid-flow, broadcast data of the broadcast program scheduled to be the next may be acquired, or broadcast data of the broadcast program scheduled to be the next may be acquired after finishing acquiring the program content currently being acquired.

Next, the preference information monitoring part A6 performs searching to find whether the preference information A51 stored in preference information storing part A5 is included in the content data stored in the program content storing part A9 or not (S5).

When the preference information A51 is included in the content data, the preference information monitoring part A6 judges that the broadcast program indicated by the content data accords with the preference information A51 and is a broadcast program which the user prefers. When judged it is not the broadcast program which the user prefers, the processing (T4-T5) of acquiring broadcast data on schedule and searching whether the preference information A51 is included or not is repeated. When judged it is the broadcast program which the user prefers, the preference information monitoring part A6 starts the event control part A71. The event control part A71 starts the event processing part A79, and the event processing part A79 performs event processing. For example, the event processing part A79 starts the memory processing part A72, acquires a program image included in the broadcast data from the broadcast data acquiring part A2, and records it in the storage in the system (S7).

According to Embodiment 1, as has been described, the broadcast receiving apparatus A0 includes one broadcast data acquiring part A2 and one record processing part A72, the broadcast data acquiring part A2 has a tuner function, the record processing part A72 has a recording function, and a plurality of programs is monitored in real time to efficiently acquire and record a scene in accord with the user's taste, depending upon the monitoring schedule stored in the monitoring schedule storing part A4, which achieves user supporting.

Moreover, according to Embodiment 1, it aims to efficiently acquire a broadcast program which the user prefers from a plurality of channels being currently broadcasted, by previously performing an acquisition scheduling of broadcast programs for acquiring program content in descending order of genre accordance between a program table and preference information, so that a channel with a high probability of including user's preference information can be preferentially monitored.

### Embodiment 2

In Embodiment 2, it will be explained the case of data of the monitoring schedule table A41 stored in the monitoring schedule storing part A4 being set by a user. Respects in Embodiment 2 and different from the ones in Embodiment 1 will be described, and the other respects are supposed to be the same as those in Embodiment 1.

FIG. 14 shows a whole configuration of the broadcast receiving apparatus A0 in Embodiment 2. In FIG. 14, the monitoring schedule generating part A3 includes a monitoring schedule input part A34. The monitoring schedule input part A34, where a user inputs data of configuring the monitoring schedule table A41, such as a broadcast program, a monitoring order for the broadcast program, continuous monitoring time, and monitoring frequency, generates the monitoring schedule table A41 based on the inputted data, and stores it in the monitoring schedule storing part A4. The broadcast acquisition scheduling part A31, the program priority storing part A32, and the program table storing part A33 shown in FIG. 2 of the Embodiment 1 may be included or may not be included. Configurations other than the above explained are supposed to be the same as those in FIG. 2 of the Embodiment 1.

Thus, according to Embodiment 2, as the broadcast receiving apparatus A0 includes the monitoring schedule input part A34, it is possible to generate the monitoring schedule table A41 by user's inputting.

### Embodiment 3

In Embodiment 3, it will be explained the case of performing an event, in addition to recording, for a broadcast program in accord with a user's taste. Respects in Embodiment 3 and different from the ones in the other Embodiments will be described, and the other respects are supposed to be the same as those in the other Embodiments.

FIG. 15 shows a configuration of the event execution part A7 described in Embodiment 3. In FIG. 15, the event processing part A79 includes the following. The record processing part A72 is a module for providing a function of performing recording operations, such as recording an image, recording sound, and storing of the program image B3, the program sound B4, and program content. A display switching processing part A73 is a module for providing a function of changing a display from the screen of a broadcast program being currently watched to a counter program. A sound notice processing part A74 is a module for providing a function of calling user's attention by playing back a chime, a bell, voice data specified by the user, etc. The sound data to be played back is stored in a sound data storing part A741. A display effect processing part A75 is a module for providing a function of calling user's attention by displaying a character sequence, an image, etc. on a screen. The display data to be displayed is stored in a display effect data storing part A751. A mail processing part A76 is a module for providing a function of sending a mail to a mail address of a user's personal computer or a user's cellular phone.

An event conditions input part A78, where a user inputs data relating to the conditions of an event to be performed when acquiring a broadcast program in accord with the user's taste, generates an event conditions table based on the inputted data and stores it in an event conditions storing part A77. For example, when an event to be performed for broadcast time of each broadcast program or for each keyword of preference information is specified by a user, the event conditions input part A78 generates an event conditions table representing an event to be performed for the specified broadcast time and keyword. The event control part A71 executes a processing part of an event represented in the event conditions table stored in the event conditions storing part A77.

Moreover, it is also acceptable for the event control part A71 to automatically judge an event to be performed and to execute it when no event conditions is input by the user. For example, when the degree of correspondence between the preference information A51 and program content is high, it is acceptable to perform the record processing part A72, and when the degree of correspondence is low, it is acceptable to perform the mail processing part A76.

Thus, according to Embodiment 3, it has been described that, with respect to a broadcast program whose character sequence in the program content accords with a keyword in the user s preference information, user supporting can be real-timely achieved by recording the broadcast program, switching a display to the broadcast program, and informing a user of various notices of the broadcast program.

### Embodiment 4

In Embodiment 4, it will be explained the case of judging broadcast programs of the same contents and monitoring a broadcast program based on the judgment result and the monitoring schedule table A41. Respects in Embodiment 4 and different from the ones in the other Embodiments will be described, and the other respects are supposed to be the same as those in the other Embodiments.

FIG. 16 is a flowchart showing processing of the broadcast receiving apparatus A0 described in Embodiment 4. The flow of processing of the broadcast receiving apparatus A0 in Embodiment 4 will be explained with reference to FIG. 16. Processing differing from FIG. 13 of Embodiment 1 will be described, and the other processing is supposed to be the same as FIG. 13 of Embodiment 1.

Processing from U1 to U4 corresponds to the processing from S1 to S4 in FIG. 13, and processing from U6 to U8 corresponds to the processing from S5 to S7 in FIG. 13.

Parallel to performing acquisition scheduling for broadcast data based on the program table A331 and acquiring the broadcast data in accordance with the schedule (U1-U4), the broadcast data acquiring part A2 performs the following.

Program content contained in the broadcast data being currently acquired is compared with program content of another broadcast program having already been acquired and having been stored in the program content storing part A9. When the rate of correspondence is high, the broadcast program being currently monitored is judged to have the same content as the compared broadcast program, and acquiring the broadcast data is stopped. Then, the next channel is monitored in accordance with the schedule and acquisition of program content is performed (U5).

Thus, according to Embodiment 4, as the broadcast receiving apparatus A0 judges a broadcast program of the same content, stops monitoring the broadcast program judged to be of the same content, and monitors the next scheduled broadcast program, it is possible to avoid performing unnecessary monitoring for the broadcast program of the same content. Consequently, the efficiency of acquiring a broadcast program in accord with a user's taste can be enhanced.

### Embodiment 5

In Embodiment 5, it will be explained the case of treating sound data and image data, as program content, in addition to text data. Respects different from the ones in the other Embodiments will be described, and the other respects are supposed to be the same as those in the other Embodiments.

FIG. 17 shows a configuration of the preference information monitoring part A6 described in Embodiment 5. The configuration of the preference information monitoring part A6 in Embodiment 5 will be explained with reference to FIG. 17.

The preference information monitoring part A6 includes a sound data identifying part A61 that identifies sound data, and an image data identifying part A62 that identifies image data.

The broadcast data acquiring part A2 stores data of the program image B3 and data of the program sound B4 in the program content storing part A9 as program content. The sound data identifying part A61 converts sound indicated by the data of the program sound B4 stored in the program content storing part A9 into characters in order to generate text data. The image data identifying part A62 analyzes an image indicated by the data of the program image B3 stored in the program content storing part A9 to generate a keyword as text data. For example, names of a person, an object, and background included in an image are generated as text data. The preference information monitoring part A6 compares the preference information A51 with the text data generated by the sound data identifying part A61 and the image data identifying part A62, to judge a broadcast program in accord with a user's taste.

Thus, according to Embodiment 5, by virtue of including the sound data identifying part A61 and the image data identifying part A62, it is possible to real-timely acquire a broadcast program in accord with a user's taste, based on the program image B3 and the program sound B4 included in broadcast data, even when text data explaining the broadcast program is not included in the broadcast data. For example, information needed by a user can be real-timely acquired from a broadcast not including text data, such as analog broadcasting.

### Embodiment 6

In Embodiment 6, it will be explained the case that a plurality of broadcast data acquiring parts is included and each of them acquires broadcast data of a different broadcast program in the same time period with respect to all broadcast programs, based on the monitoring schedule table A41. Respects different from the ones in the other Embodiments will be described, and the other respects are supposed to be the same as those in the other Embodiments.

FIG. 18 shows a relation between the broadcast data acquiring part in Embodiment 6 and a broadcast channel to be monitored. The relation between the broadcast data acquiring part in Embodiment 6 and a channel through which a broadcast program to acquire broadcast data is broadcasted will be explained with reference to FIG. 18.

The broadcast receiving apparatus A0 includes m broadcast data acquiring parts: a first broadcast data acquiring part C11, a second broadcast data acquiring part C12, . . . , a m-th broadcast data acquiring part C1m.

Each broadcast data acquiring part acquires each broadcast data of a first broadcast channel D1, a second broadcast channel D2, a n-th broadcast channel Dn which are performing broadcasting in the same time period, based on the monitoring schedule table A41. At this time, each broadcast data acquiring part acquires broadcast data of mutually different broadcast channels. That is, there are no broadcast data acquiring parts that mutually acquire broadcast data of the same broadcast channel at the same time.

In order for a plurality of broadcast data acquiring parts to acquire broadcast data of a plurality of broadcast channels without overlapping, each broadcast data acquiring part may include the monitoring schedule table A41 that is scheduled not to have overlapping of broadcast channels to acquire broadcast data in relation to other broadcast data acquiring part.

Moreover, for one monitoring schedule table A41, it is acceptable that when acquiring broadcast data, each broadcast data acquiring part sets data representing under acquisition of broadcast data for the broadcast channel, and when changing broadcast channels, each broadcast data acquiring part selects a broadcast channel for which the data representing under acquisition of broadcast data is not set.

Thus, according to Embodiment 6, by virtue of including a plurality of broadcast data acquiring parts, frequency of monitoring each broadcast program becomes high compared with monitoring by one broadcast data acquiring part, and the total monitoring time of each broadcast program increases. Consequently, the probability of acquiring information which the user prefers can be enhanced.

### Embodiment 7

In Embodiment 7, it will be explained the case that a plurality of broadcast data acquiring parts is included and each of them acquires broadcast data of a different broadcast program in the same time period with respect to one or more than one broadcast programs differing from each other, based on the monitoring schedule table A41. Respects different from the ones in the other Embodiments will be described, and the other respects are supposed to be the same as those in the other Embodiments.

FIG. 19 shows a relation, in Embodiment 7, between the broadcast data acquiring part and a broadcast channel to be monitored. The relation, in Embodiment 7, between the broadcast program data acquiring part and a channel through which a broadcast program to acquire broadcast data is broadcasted will be explained with reference to FIG. 19.

The broadcast receiving apparatus A0 includes m broadcast data acquiring parts: a first broadcast data acquiring part C21, a second broadcast data acquiring part C22, . . . , a m-th broadcast data acquiring part C2m. Each broadcast data acquiring part acquires broadcast data of a different broadcast channel. For example, the first broadcast data acquiring part C21 acquires broadcast data from the first broadcast channel D1, the second broadcast channel D2, and the third broadcast channel D3. The second broadcast data acquiring part C22 acquires broadcast data from the fourth broadcast channel D4, the fifth broadcast channel D5, and the sixth broadcast channel D6.

In this case, the order, the time and the frequency of acquiring broadcast data of each broadcast channel by each broadcast data acquiring part are based on the monitoring schedule table A41. Moreover, not to perform overlapping of broadcast channels between broadcast data acquiring parts, the monitoring schedule table A41 is generated for each broadcast data acquiring part. Further, it is also acceptable to have one monitoring schedule table A41 and to set data indicating a broadcast data acquiring part in charge, with respect to each broadcast channel in the schedule. This enables each broadcast data acquiring part to acquire broadcast data of a different broadcast program in the same time period, based on the monitoring schedule table A41.

Thus, according to Embodiment 7, by including a plurality of broadcast data acquiring parts and acquiring broadcast data of broadcast channels differing from each other, it is possible to mitigate the processing load of each broadcast data acquiring part. Moreover, as a monitor channel range is narrowed, the total monitoring time of each broadcast program increases. Consequently, the probability of acquiring information of the user's taste can be enhanced.

### Embodiment 8

In Embodiment 8, it will be explained the case that a plurality of broadcast data acquiring parts is included, some of the broadcast data acquiring parts acquire broadcast data of the broadcast program judged to be in accord with preference information by the preference information monitoring part A6, and the other broadcast data acquiring parts acquire broadcast data of different broadcast programs in the same time period based on a monitoring schedule table. Respects different from the ones in the other Embodiments will be described, and the other respects are supposed to be the same as those in the other Embodiments.

FIG. 20 shows a relation, in Embodiment 8, between a broadcast data acquiring part and a broadcast channel to be monitored. The relation, in Embodiment 8, between the broadcast program data acquiring part and a channel through which a broadcast program to acquire broadcast data is broadcasted will be explained with reference to FIG. 20.

The broadcast receiving apparatus A0 includes m broadcast data acquiring parts: a first broadcast data acquiring part C31, a second broadcast data acquiring part C32, . . . , a m-th broadcast data acquiring part C3m.

Some of the broadcast data acquiring parts acquire broadcast data of the broadcast program judged to be in accord with a user's taste by the preference information monitoring part A6. The other broadcast data acquiring parts acquire broadcast data of the other broadcast programs, and the preference information monitoring part A6 monitors broadcast programs in accord with the user's taste.

For example, when the preference information monitoring part A6 judges a broadcast program of a (n-2)th broadcast channel Dn-2 to be a broadcast program in accord with a user's taste, the m-th broadcast data acquiring part C3m acquires broadcast data of the (n-2)th broadcast channel Dn-2 and outputs it to the record processing part A72 in order to record the broadcast program. Other broadcast data acquiring parts acquire broadcast data of different broadcast channels based on the monitoring schedule table A41, and the preference information monitoring part A6 monitors whether there is any broadcast program in accord with the user's taste or not. The method of acquiring broadcast data of a different broadcast channel by each broadcast data acquiring part is the same as that of Embodiment 6 and Embodiment 7.

According to Embodiment 8, as a plurality of broadcast data acquiring parts is included, some broadcast data acquiring parts acquire broadcast data of the broadcast program judged by the preference information monitoring part A6 to be in accord with a user's taste, and the other broadcast data acquiring parts acquire broadcast data of broadcast programs differing from each other. Even when a certain broadcast data acquiring part is occupied because of its recording a certain broadcast program, as other broadcast data acquiring parts perform monitoring, it is possible to enhance the probability of acquiring information which the user prefers.

For example, in the case of there being one broadcast data acquiring part, it is possible to record a broadcast program at the time of acquiring broadcast data of the broadcast program, and it is impossible to monitor and acquire a plurality of other broadcast programs in the same time period, i.e. counter programs. However, in accordance with Embodiment 8, it becomes possible.

According to each Embodiment, as has been explained, the broadcast receiving apparatus A0 is a real-time user support system of a plurality of channels that real-timely provides information which a user prefers from a plurality of channels, in a broadcast environment where a plurality of channels is executed repeatedly at random.

Moreover, as has been explained, the broadcast receiving apparatus includes the program table storing part A33 that stores program tables of a plurality of channels, the broadcast acquisition scheduling part A31 that acquires program contents of broadcast programs in descending order of a monitoring priority based on a program table, the broadcast data acquiring part A2 that can acquire a program table and can acquire a broadcast program based on the monitoring schedule, the preference information monitoring part A6 that checks whether information in accord with a user's preference information is included in the acquired program content or not, and the event control part A71 that performs directions for operations, such as recording and displaying, when being in accord with the user's preference information.

Moreover, as has been explained, the broadcast acquisition scheduling part A31 compares information included in a program table, such as a performer list and a program genre, with user's preference information, and performs priority setting so that a program acquisition priority of a program including user's preference information of the same performer and the same program genre may be high.

Moreover, as has been explained, in order to enhance the probability of acquiring a channel with a high program acquisition priority, the broadcast acquisition scheduling part A31 performs scheduling to lengthen total monitoring time of a channel with a high acquisition priority, and creates a monitoring schedule.

Moreover, as has been explained, in order to enhance the probability of acquiring a channel with a high program acquisition priority, the broadcast acquisition scheduling part A31 performs scheduling to increase monitoring frequency of a channel with a high acquisition priority, and creates a monitoring schedule.

Moreover, as has been explained, the broadcast acquisition scheduling part A31 is able to create a monitoring schedule by combining scheduling methods.

Moreover, as has been explained, the broadcast data acquiring part A2 acquires a program image and program content from a plurality of channels, based on the monitoring schedule.

Moreover, as has been explained, in the case of monitoring around a plurality of channels in order of a program content schedule, when predetermined time has passed even in the middle of receiving content, the broadcast data acquiring part A2 monitors the next channel to acquire program content.

Moreover, as has been explained, in the case of monitoring around a plurality of channels in order of a program content schedule, after completely receiving program content, the broadcast data acquiring part A2 monitors the next channel to acquire program content.

Moreover, as has been explained, in the case of monitoring around a plurality of channels in order of a program content schedule, the broadcast data acquiring part A2 compares them with the program content having been received, judges one to be the same content when the rate of correspondence is high, stops acquiring it, and performs monitoring the next channel to acquire program content.

Moreover, as has been explained, the broadcast data acquiring part A2 is able to combine the acquisition methods to acquire program content.

Moreover, as has been explained, it is acceptable two or more than two broadcast data acquiring parts A2 exist, and it is possible to separate processing of each into recording processing and a program content acquisition part.

Moreover, as has been explained, it is acceptable two or more than two broadcast data acquiring parts A2 exist, and it is possible to increase the number of program content to acquire simultaneously in virtue of monitoring all the channels by each of the broadcast data acquiring parts A2.

Moreover, as has been explained, it is acceptable two or more than two broadcast data acquiring parts A2 exist, and it is possible to increase the number of program content to acquire simultaneously in virtue of dividing a plurality of channels into channels of the same number as the broadcast data acquiring parts A2 and monitoring them by each of the broadcast data acquiring parts A2 within its range.

In accordance with each Embodiment, it is possible to automatically record a scene which a user prefers in digital broadcasting as follows.

The digital broadcast program, such as digital television broadcast and digital radio broadcast, includes content information called a BML (Broadcast Markup Language) in addition to images and sound. Further, it is possible to acquire a program table called an EPG (Electronic Program Guide). The keyword of an image which a user desires to record is stored beforehand as preference information. For example, if the user desires to store only a shooting scene of soccer, etc., the keyword is set as “shoot”, and if the user desires to store only a matching scene of a sumo wrestler XYZ, the keyword is set as “sumo wrestler XYZ”.

Based on the degree of genre correspondence between the EPG and these keywords, the broadcast acquisition scheduling part A31 generates the monitoring schedule table A41, in which the total monitoring time of broadcast programs of soccer and sumo wrestling is made to be long.

Then, the preference information monitoring part A6 searches whether a character sequence of “shoot” or “sumo wrestler XYZ” is included in the acquired program content or not. At the time of the keyword accordance, the preference information monitoring part A6 starts the record processing part A72 simultaneously through the event control part A71 in order to record the broadcast program for predetermined time period.

By virtue of this, it is possible for a user to efficiently record a scene which he/she needs. Since a scene which the user is not interested in is not recorded, useless recording storage can be avoided. Moreover, since the user does not need to monitor a plurality of broadcast programs by zapping etc., time and effort can be saved. Unlike the automatic recording system utilizing only a program table, it is possible to record a scene which the user prefers in real time from the information not represented in the program table, in a live broadcast program being difficult to create a program table, in a movie being difficult to describe a story outline in detail, etc.

Furthermore, automatic display switching of a scene which a user prefers in digital broadcasting can be performed as follows.

The digital broadcast program, such as digital television broadcast and digital radio broadcast, includes content information called the BML in addition to images and sound. Further, it is possible to acquire a program table called the EPG. The keyword of an image which a user desires to record is stored beforehand as preference information. For example, if the user desires to watch only a shooting scene of soccer, etc. being broadcasted as a counter program, the keyword is set as “shoot”, and if the user desires to watch only a matching scene of a sumo wrestler XYZ, the keyword is set as “sumo wrestler XYZ”.

Based on the degree of genre correspondence between the EPG and these keywords, the broadcast acquisition scheduling part A31 generates the monitoring schedule table A41, in which the total monitoring time of broadcast programs of soccer and sumo wrestling is made to be long.

Then, the preference information monitoring part A6 searches whether the character sequence of “shoot” or “sumo wrestler XYZ” is included in the acquired program content or not. At the time of the keyword accordance, the preference information monitoring part A6 starts the display switching processing part A73 simultaneously through the event control part A71 in order to change a display from the channel being currently watched to the channel broadcasting the shooting scene.

By virtue of this, it is possible for a user to efficiently watch a scene which he/she needs. Since the user does not need to monitor a plurality of broadcast programs by zapping etc., time and effort can be saved. As it is not necessary to monitor a scene which the user desires to watch in a live broadcast, etc. where program content is variable, and as a display switching is automatically performed even in a counter program, the user does not need to care about a program to watch.

Furthermore, automatic recording of a scene which a user prefers in analog broadcasting can be performed as follows.

It is also possible to acquire a program table by the EPG in the analog broadcasting, such as television broadcast and radio broadcast.

The keyword of an image which a user desires to record is stored beforehand as preference information. For example, if the user desires to store only a shooting scene of soccer, etc., the keyword is set as “shoot”, and if the user desires to store only a matching scene of a sumo wrestler XYZ, the keyword is set as “sumo wrestler XYZ”.

Based on the degree of genre correspondence between the EPG and these keywords, the broadcast acquisition scheduling part A31 generates the monitoring schedule table A41, in which the total monitoring time of broadcast programs of soccer and sumo wrestling is made to be long.

Then, the preference information monitoring part A6 monitors whether sound of “shoot” or “sumo wrestler XYZ” is included in the acquired program content or not, by using the sound data identifying part A61. At the time of the keyword accordance, the preference information monitoring part A6 starts the record processing part A72 simultaneously through the event control part A71 in order to record the broadcast program for predetermined time period.

By virtue of this, it is possible for a user to efficiently record a scene which he/she needs. Since a scene which the user is not interested in is not recorded, useless recording storage can be avoided. Moreover, since the user does not need to monitor around a plurality of broadcast programs by zapping etc., time and effort can be saved. Unlike the automatic recording system utilizing only a program table, it is possible to record a scene which the user prefers in real time from the information not represented in the program table, in a live broadcast program being difficult to create a program table, in a movie being difficult to describe a story outline in detail, etc.

Furthermore, automatic display switching of a scene which a user prefers in analog broadcasting can be performed as follows.

It is also possible to acquire a program table by the EPG in the analog broadcasting, such as television broadcast and radio broadcast.

The keyword of an image which a user desires to watch is stored beforehand as preference information. For example, if the user desires to watch only a shooting scene of soccer, etc., the keyword is set as “shoot”, and if the user desires to watch only a matching scene of a sumo wrestler XYZ, the keyword is set as “sumo wrestler XYZ”.

Based on the degree of genre correspondence between the EPG and these keywords, the broadcast acquisition scheduling part A31 generates the monitoring schedule table A41, in which the total monitoring time of broadcast programs of soccer and sumo wrestling is made to be long.

Then, the preference information monitoring part A6 monitors whether sound of “shoot” or “sumo wrestler XYZ” is included in the acquired program content or not, by using the sound data identifying part A61. At the time of the keyword accordance, the preference information monitoring part A6 starts the display switching processing part A73 simultaneously through the event control part A71 to change the display to the broadcast program.

By virtue of this, it is possible for a user to efficiently watch a scene which he/she needs. Since the user does not need to monitor a plurality of broadcast programs by zapping etc., time and effort can be saved. As it is not necessary to monitor a scene which the user desires to watch in a live broadcast, etc. where program content is variable, and as display switching is automatically performed even in a counter program, the user does not need to care about a program to watch.

Furthermore, sound notice for a scene which a user prefers in television broadcasting and radio broadcasting can be performed as follows.

It is also possible to acquire a program table by the EPG in the analog broadcasting, such as television broadcast and radio broadcast.

The keyword of an image which a user desires to watch is stored beforehand as preference information. For example, if the user desires to watch only a shooting scene of soccer, etc., the keyword is set as “shoot”, and if the user desires to watch only a matching scene of a sumo wrestler XYZ, the keyword is set as “sumo wrestler XYZ”.

Based on the degree of genre correspondence between the EPG and these keywords, the broadcast acquisition scheduling part A31 generates the monitoring schedule table A41, in which the total monitoring time of broadcast programs of soccer and sumo wrestling is made to be long.

Then, the preference information monitoring part A6 monitors whether a character sequence or sound of “shoot” or “sumo wrestler XYZ” is included in the acquired program content or not. At the time of the keyword accordance, the preference information monitoring part A6 starts the sound notice processing part A74 simultaneously through the event control part A71 to call attention for a program which the user prefers being currently broadcasted in a counter program, by alerting with sound, such as a chime.

By virtue of this, it is possible for a user to reduce the probability of missing a scene which he/she desires to watch. Since a user does not need to monitor a plurality of broadcast programs by zapping etc., time and effort can be saved. It is effective in a program, such as a live broadcast where program content is variable.

Furthermore, character notice for a scene which a user prefers in television broadcasting and radio broadcasting can be performed as follows.

It is also possible to acquire a program table by the EPG in the analog broadcasting, such as television broadcast and radio broadcast.

The keyword of an image which a user desires to watch is stored beforehand as preference information. For example, if the user desires to watch only a shooting scene of soccer, etc., the keyword is set as “shoot”, and if the user desires to watch only a matching scene of a sumo wrestler XYZ, the keyword is set as “sumo wrestler XYZ”.

Based on the degree of genre correspondence between the EPG and these keywords, the broadcast acquisition scheduling part A31 generates the monitoring schedule table A41 to lengthen the total monitoring time of broadcast programs of soccer and sumo wrestling.

Then, the preference information monitoring part A6 monitors whether a character sequence or sound of “shoot” or “sumo wrestler XYZ” is included in the acquired program content or not. At the time of the keyword accordance, the preference information monitoring part A6 starts the display effect processing part A75 simultaneously through the event control part A71 to call attention by displaying that a program according the user's taste is being broadcasted in a counter program as character information on the screen.

By virtue of this, it is possible for a user to reduce the probability of missing a scene which he/she desires to watch. Since the user does not need to monitor a plurality of broadcast programs by zapping etc., time and effort can be saved. It is effective in a program, such as a live broadcast where program content is variable.

Furthermore, mailing notice for a scene which a user prefers in television broadcasting and radio broadcasting can be performed as follows.

It is also possible to acquire a program table by the EPG in the analog broadcasting, such as television broadcast and radio broadcast.

The keyword of an image which a user desires to watch is stored beforehand as preference information. For example, if the user desires to watch only a shooting scene of soccer, etc., the keyword is set as “shoot”, and if the user desires to watch only a matching scene of a sumo wrestler XYZ, the keyword is set as “sumo wrestler XYZ”.

Based on the degree of genre correspondence between the EPG and these keywords, the broadcast acquisition scheduling part A31 generates the monitoring schedule table A41, in which the total monitoring time of broadcast programs of soccer and sumo wrestling is made to be long.

Then, the preference information monitoring part A6 monitors whether a character sequence or sound of “shoot” or “sumo wrestler XYZ” is included in the acquired program content or not. At the time of the keyword accordance, the preference information monitoring part A6 starts the mail processing part A76 simultaneously through the event control part A71 to call attention by sending mail notice that a program according the user's taste is being broadcasted in a counter program to the user's cellular phone or personal computer.

By virtue of this, it is possible for a user to reduce the probability of missing a scene which he/she desires to watch. Even when the user is not at the television or the radio because of being away from home, he/she is able to know whether a scene which he/she desires to watch is being broadcasted or not. When the present system and a cellular phone configure a network, such as the Internet, recording etc. can be remotely performed based on the notice information. Therefore, even when the user is in a remote place, he/she is able to know whether a scene which he/she desires to watch is being broadcasted or not.

Furthermore, sensor information can be acquired as follows.

Each Embodiment can be applied to a system which efficiently acquires information sent from an electronic tag or a sensor, such as RFID (Radio Frequency IDentification.) In the case of many sensors existing around a user, it is highly requested to have a system by which sensor information can be efficiently acquired in order to automatically obtain information needed by a user. As the sensor information emits electric waves repeatedly at random, this information can be regarded as broadcast. At this time, information on the number and the type of sensors existing around the user can be regarded as a program table and information which the user previously desires to acquire can be regarded as preference information. In this case, the sensor includes an identification number like RFID beforehand.

First, the broadcast data acquiring part A2 acquires the number and the type of sensors existing around the user.

Next, the broadcast acquisition scheduling part A31 compares these pieces of information with preference information, and creates the monitoring schedule table A41 so that the user can acquire information needed. Based on the monitoring schedule table A41, surrounding sensor information is monitored around and acquired. The preference information monitoring part A6 searches sensor information in accord with the user's preference information, and transmits the event which corresponds to the preference.

For example, when a user is looking for a green pepper in a supermarket, the user inputs “green pepper” into a cellular phone etc. with a RFID reading function. In this case, the keyword of the user's preference information is “green pepper”, and the kind is vegetables. Although there are various foods in a supermarket, monitor scheduling is performed so that information on vegetables, being the kind of green peppers, can be preferentially acquired first. Next, a green pepper is searched in the vegetables, and if the green pepper is found, its presence is displayed on the screen of the cellular phone.

Therefore, it is possible to exactly acquire information which the user desires to obtain in many pieces of sensor information and to automatically execute an operation which the user requests.

Moreover, acquiring a scene which a user prefers can be performed in the Internet streaming broadcast as follows.

There is a plurality of channels in the Internet streaming broadcast like the television broadcasting. A portal site of streaming broadcast can be a substitute for a program table. The portal site is the gateway to the streaming broadcast site being currently broadcasted, and it can be regarded as a program table of the streaming broadcast. First, a genre of user's taste is compared with the portal site, and monitor scheduling is performed so that total monitoring time of streaming broadcast with a high probability of including a scene which the user prefers may become long. Storing and display switching are automatically performed for a scene where program content or program sound of streaming broadcast being currently monitored accords with a keyword of the preference information.

Thus, according to the above, it is possible to automatically perform storing and display switching of a program which accords with a user's preference, in a plurality of broadcasts in the Internet broadcast.

### BRIEF DESCRIPTION OF THE DRAWINGS

FIG. 1 shows a hardware configuration of a broadcast receiving apparatus A0 described in Embodiment 1;

FIG. 2 shows a whole configuration of the broadcast receiving apparatus A0 described in Embodiment 1;

FIG. 3 shows a broadcast program described in Embodiment 1;

FIG. 4 shows a program table A331 stored in a program table storing part A33 described in Embodiment 1;

FIG. 5 shows preference information A51 of a user stored in a preference information storing part A5 described in Embodiment 1;

FIG. 6 shows preference information A51 of a user stored in the preference information storing part A5 described in Embodiment 1;

FIG. 7 shows a program priority table A321 stored in a program priority storing part A32 described in Embodiment 1;

FIG. 8 shows the program priority table A321 stored in the program priority storing part A32 described in Embodiment 1;

FIG. 9 shows a monitoring schedule table A41 stored in a monitoring schedule storing part A4 described in Embodiment 1;

FIG. 10 shows the monitoring schedule table A41 stored in the monitoring schedule storing part A4 described in Embodiment 1;

FIG. 11 shows the monitoring schedule table A41 stored in the monitoring schedule storing part A4 described in Embodiment 1;

FIG. 12 is a flowchart showing processing of a broadcast acquisition scheduling part A31 described in Embodiment 1;

FIG. 13 is a flowchart showing processing of the broadcast receiving apparatus A0 described in Embodiment 1;

FIG. 14 shows a whole configuration of the broadcast receiving apparatus A0 in Embodiment 2;

FIG. 15 shows a configuration of an event execution part A7 described in Embodiment 3;

FIG. 16 is a flowchart showing processing of the broadcast receiving apparatus A0 described in Embodiment 4;

FIG. 17 shows a configuration of a preference information monitoring part A6 described in Embodiment 5;

FIG. 18 shows a relation, in Embodiment 6, between a broadcast data acquiring part and a broadcast channel to be monitored;

FIG. 19 shows a relation, in Embodiment 7, between a broadcast data acquiring part and a broadcast channel to be monitored; and

FIG. 20 shows a relation, in Embodiment 8, between a broadcast data acquiring part and a broadcast channel to be monitored.

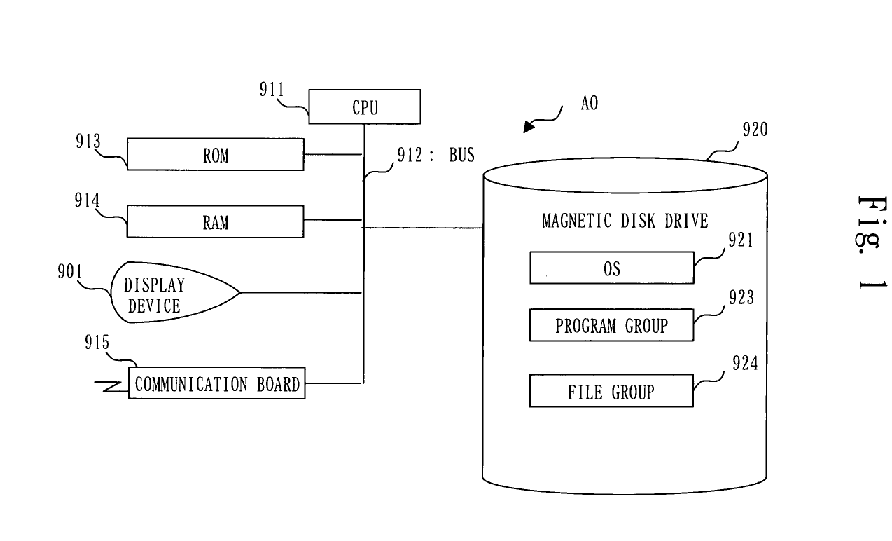

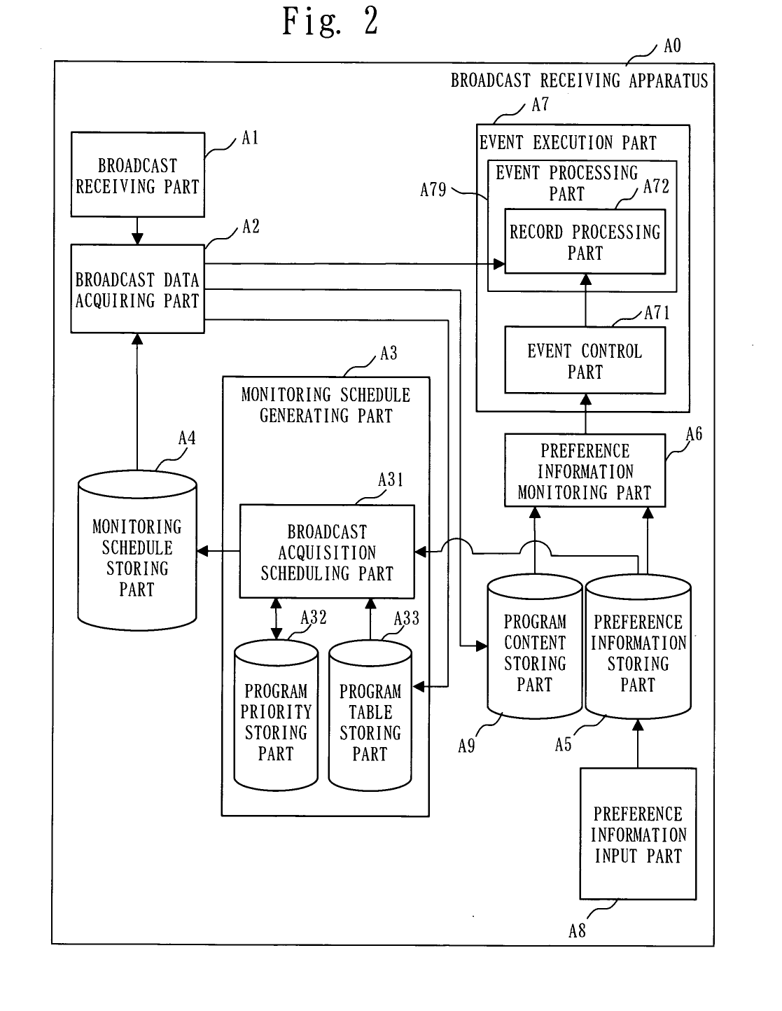

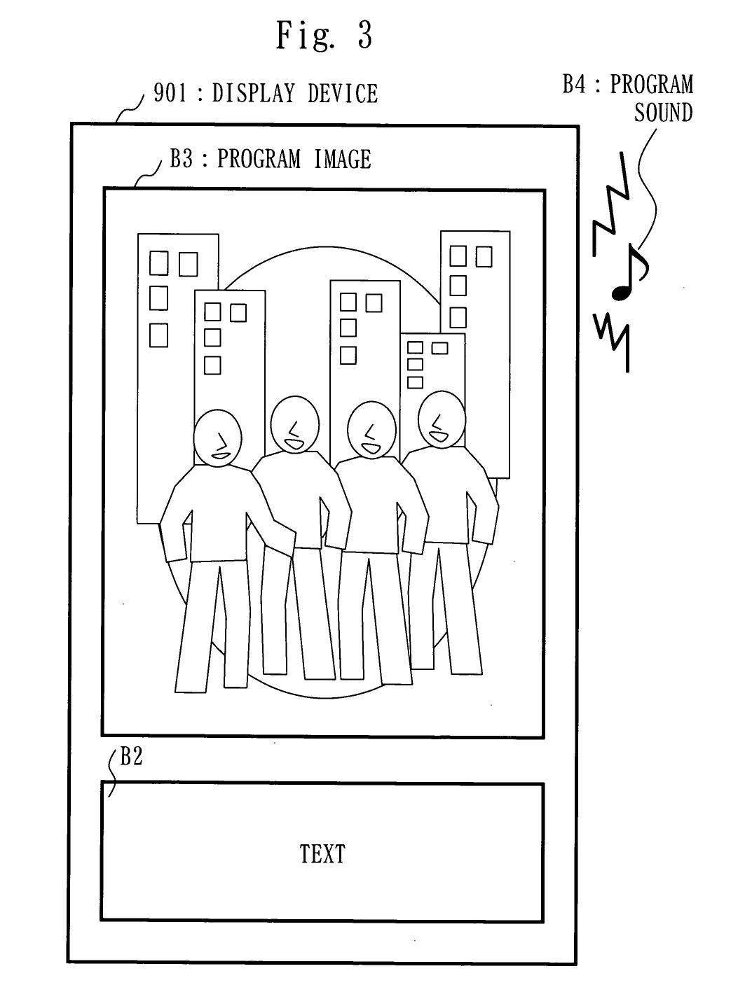

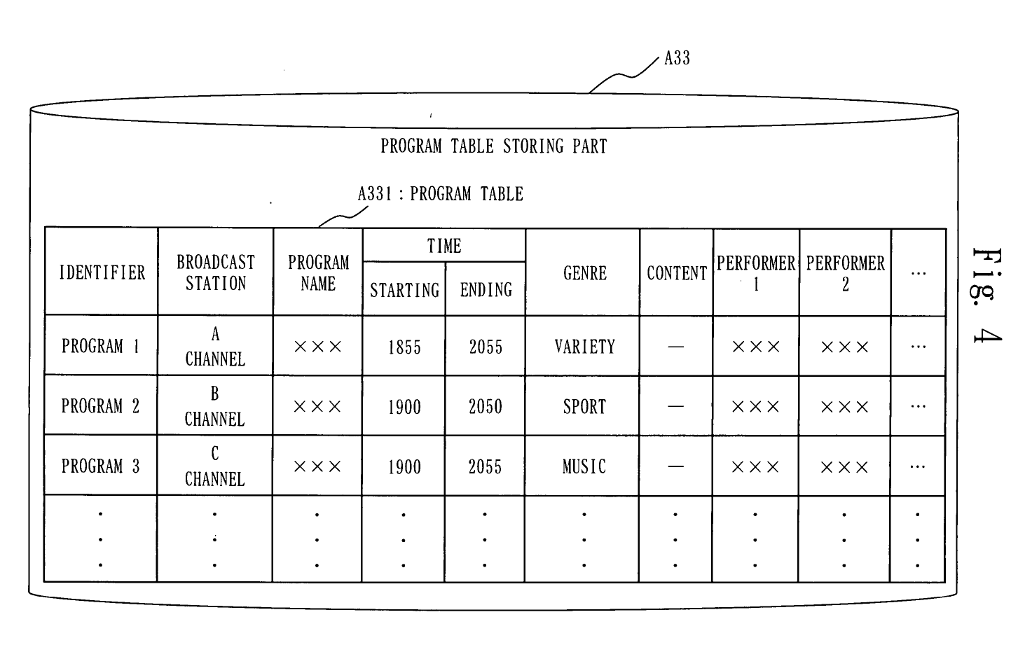

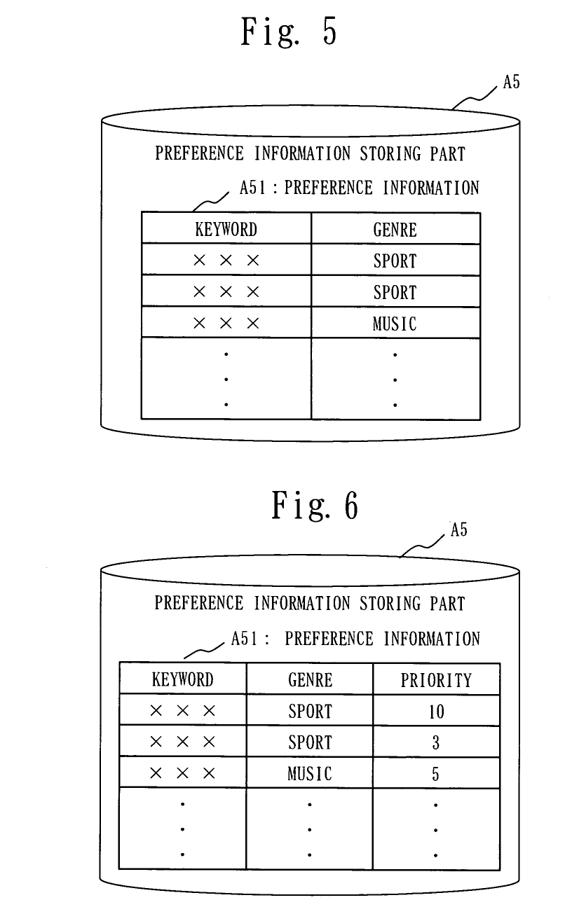

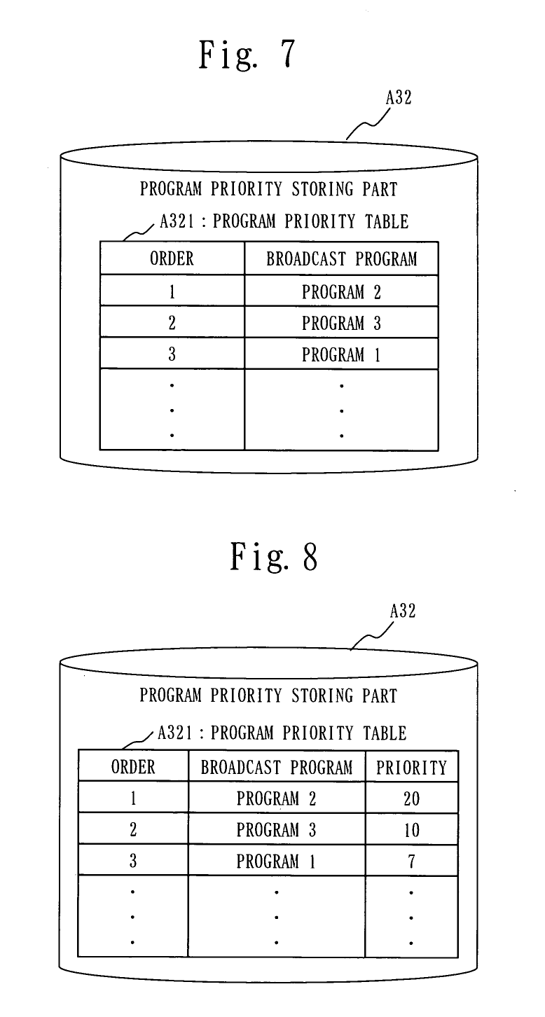

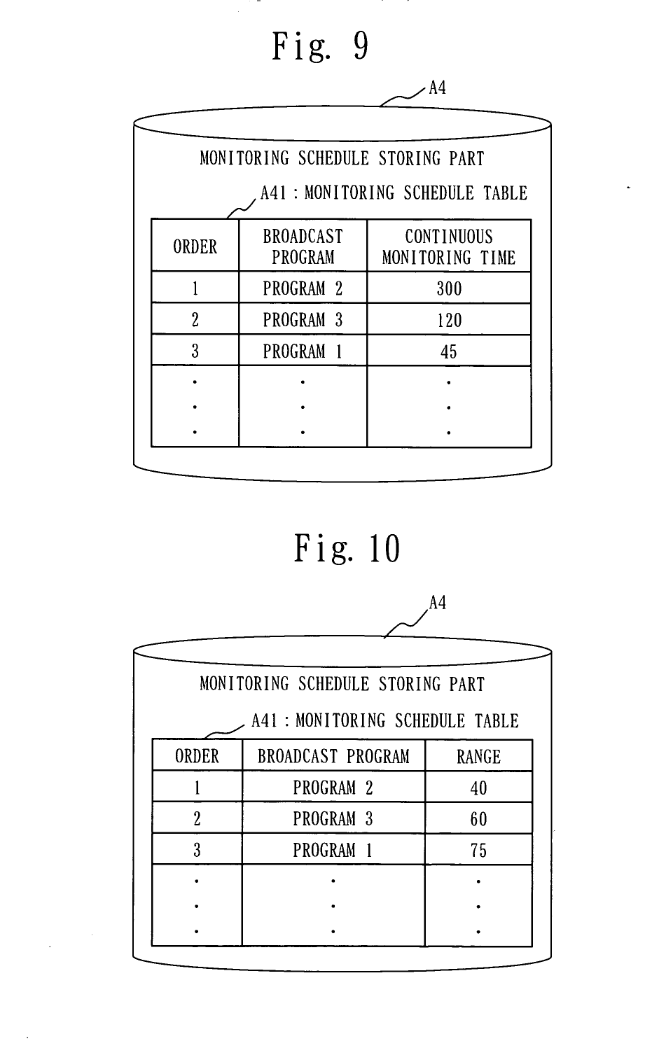

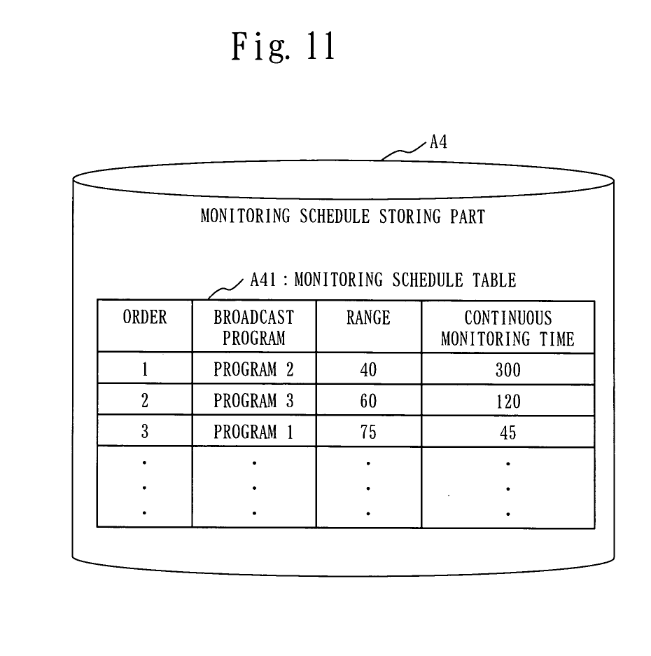

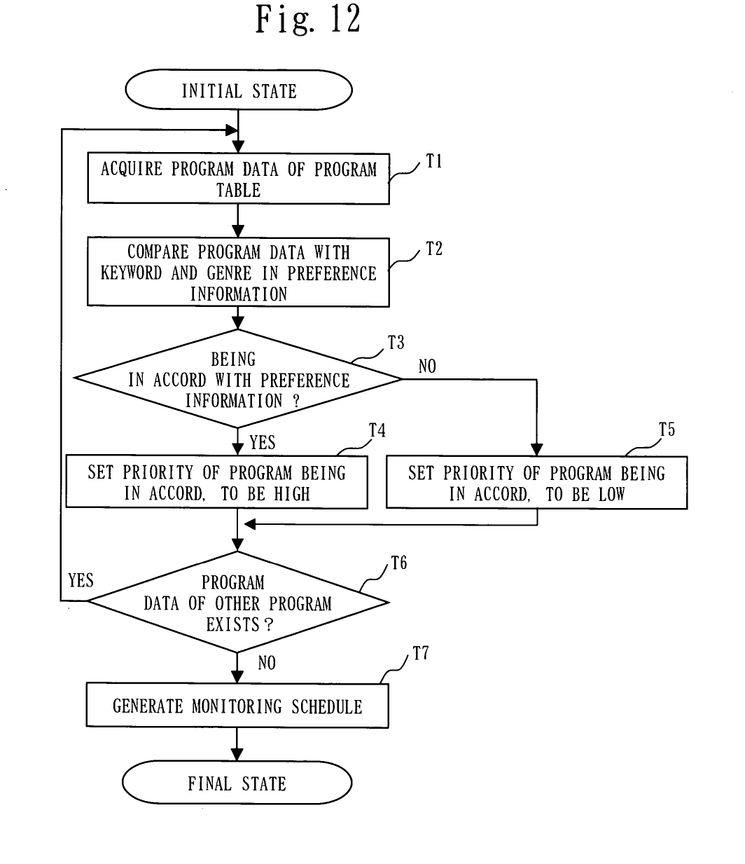

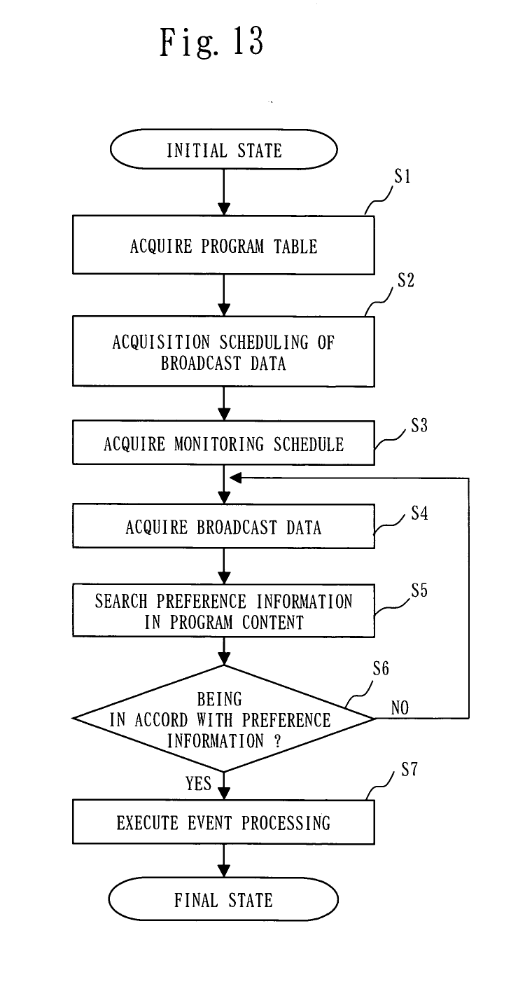

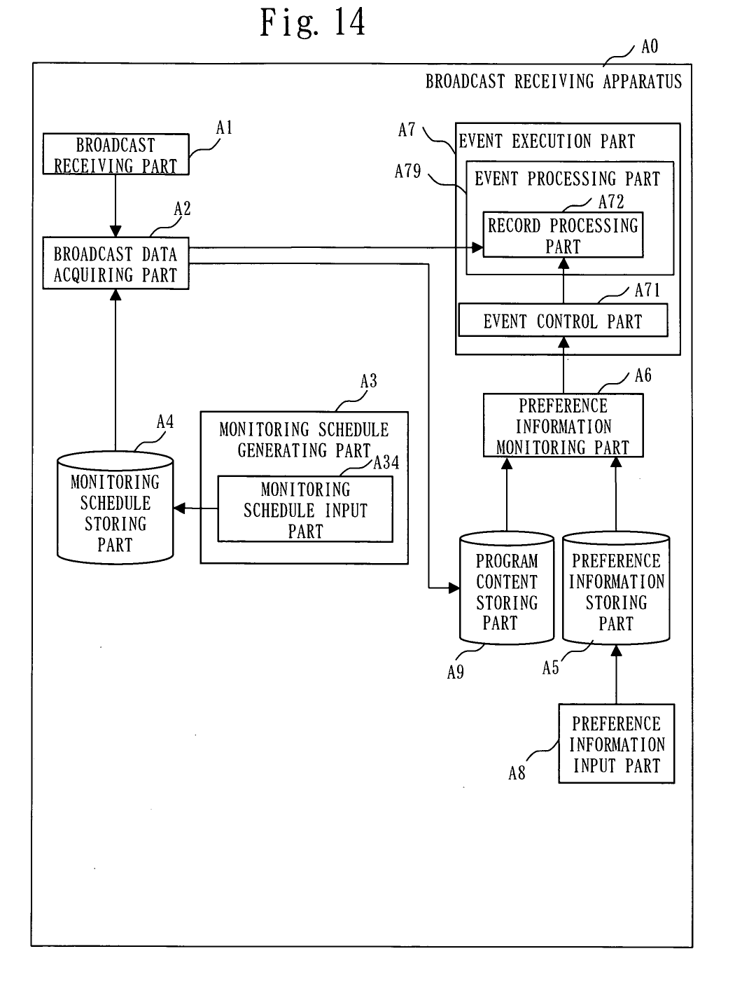

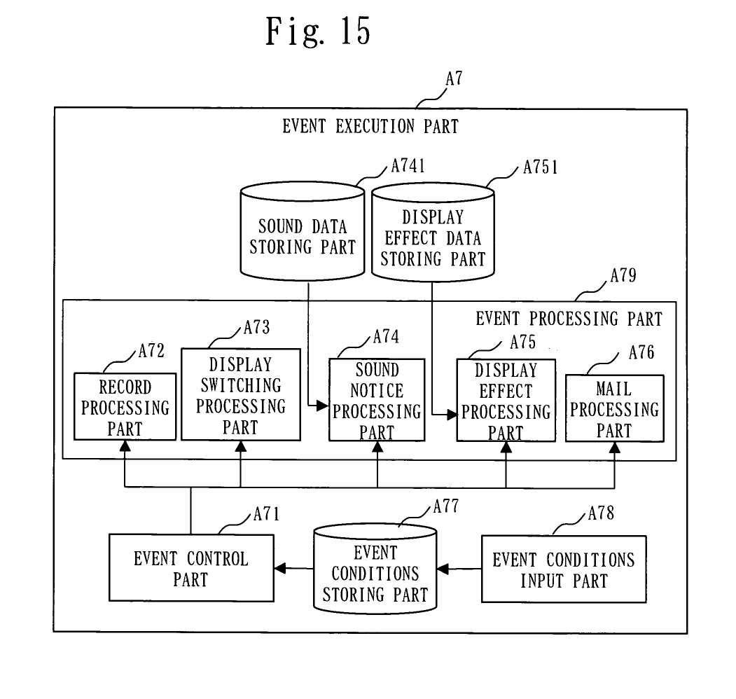

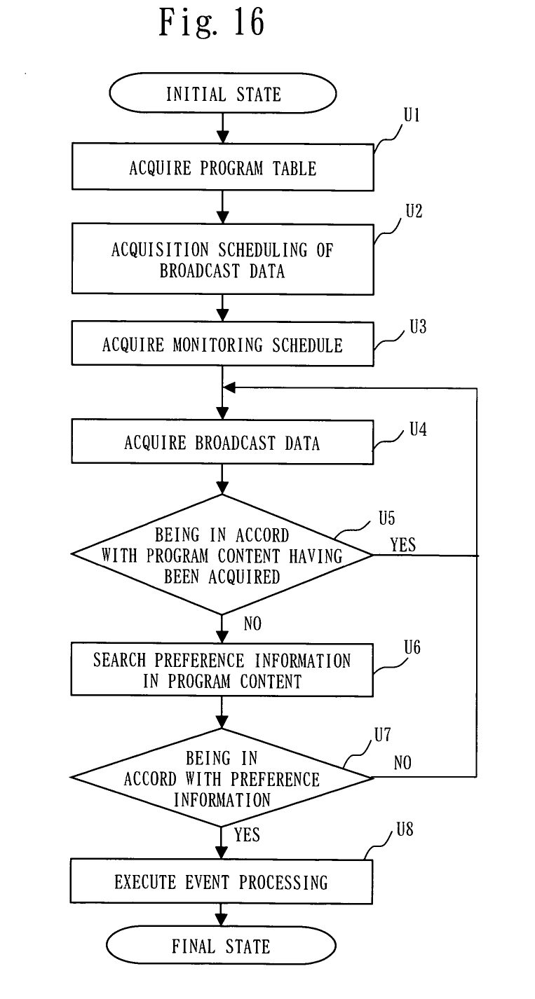

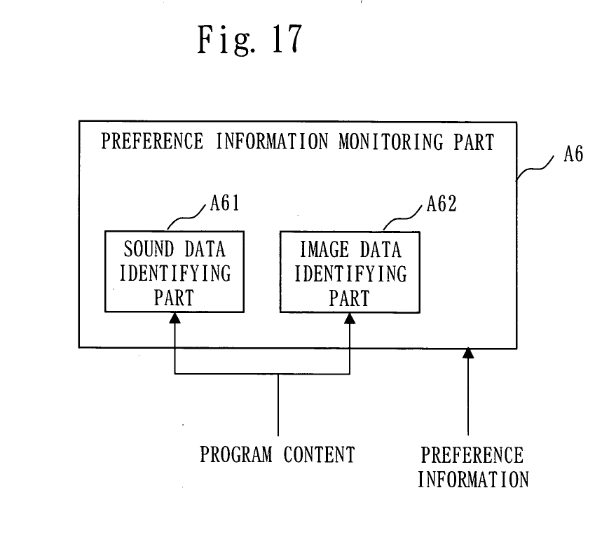

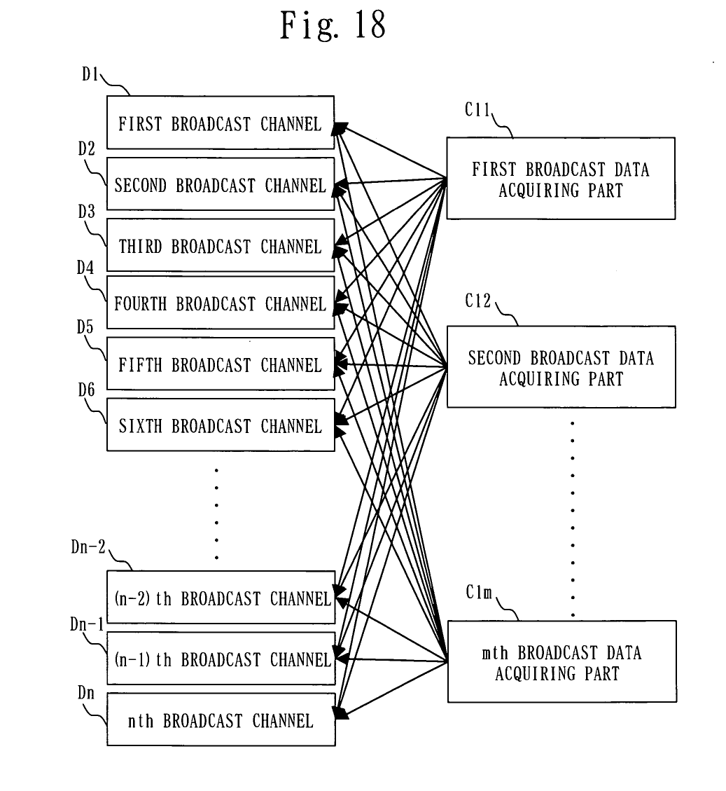

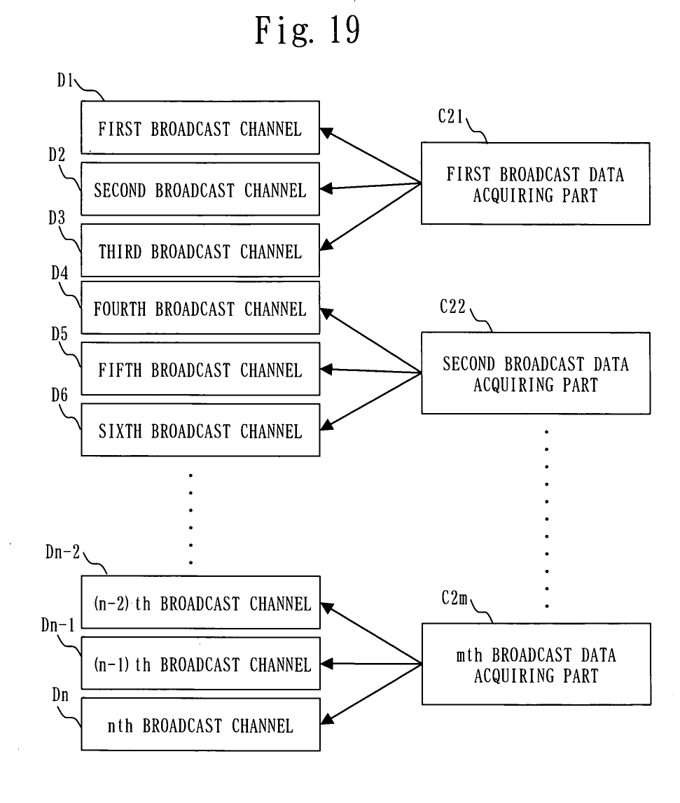

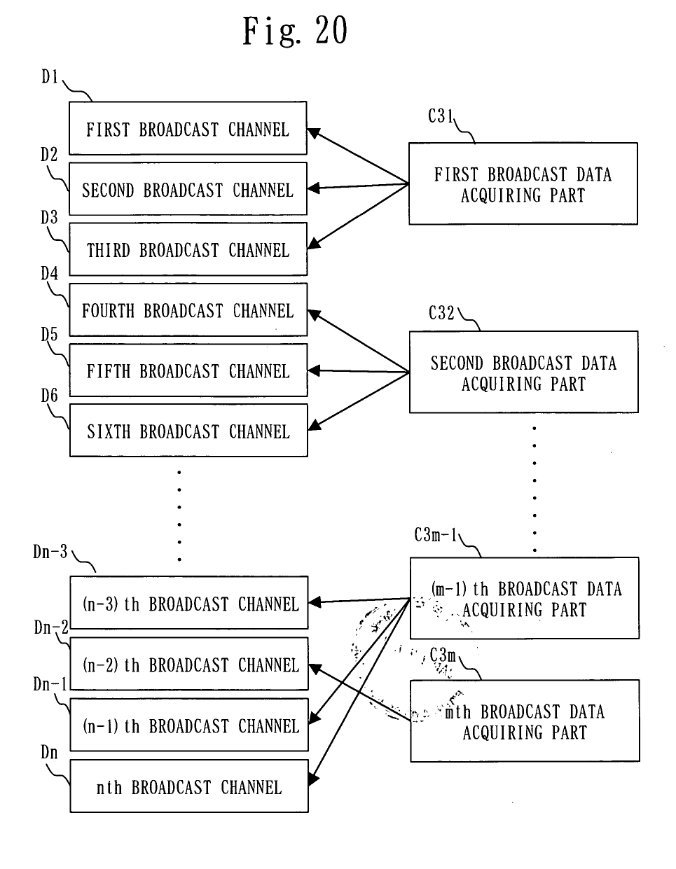

1. A broadcast receiving apparatus that judges a broadcast program in accord with preference information comprising:
a preference information storing part to store preference information;
a monitoring schedule storing part to store a monitoring schedule table that indicates a monitoring schedule for each broadcast program in the same time period;
a broadcast data acquiring part to acquire broadcast data relating to a broadcast program; and
a preference information monitoring part to judge whether a broadcast program being currently monitored is in accord with the preference information,
wherein the broadcast data acquiring part acquires the broadcast data of each broadcast program in the same time period, based on the monitoring schedule table stored in the monitoring schedule storing part, and
the preference information monitoring part compares the broadcast data acquired by the broadcast data acquiring part with the preference information stored in the preference information storing part, and judges whether the broadcast program indicated by a compared broadcast data accords with the preference information.

2. The broadcast receiving apparatus according to claim 1 further comprising:
a program table storing part to store a program table being data that indicates broadcast content of each broadcast program in each time period;
a program priority storing part to store a program priority table that indicates a priority of a broadcast program for acquiring broadcast data; and
a broadcast acquisition scheduling part to generate the monitoring schedule table,
wherein the broadcast data acquiring part acquires a program table as broadcast data, and stores an acquired program table in the program table storing part, and
the broadcast acquisition scheduling part compares the broadcast content of each broadcast program in each time period indicated by the program table stored in the program table storing part with the preference information stored in the preference information storing part, judges priority of each broadcast program in each time period to be corresponding to the preference information, generates a program priority table based on a judged priority, stores a generated program priority table in the program priority storing part, generates a monitoring schedule table by determining a monitoring schedule for each broadcast program in each time period, based on the program priority table stored in the program priority storing part, and stores a generated monitoring schedule table in the monitoring schedule storing part.

3. The broadcast receiving apparatus according to claim 2, wherein the broadcast acquisition scheduling part determines a monitoring schedule by making at least one of continuous monitoring time and monitoring frequency be corresponding to the priority of each broadcast program indicated by the program priority table stored in the program priority storing part.

4. The broadcast receiving apparatus according to claim 1 further comprising:
an event execution part to execute various types of events, which includes an event processing part, and an event control part to control the event processing part,
wherein the event processing part includes at least one of
a record processing part to record broadcast data;
a display switching processing part to switch broadcast data to display;
a sound notice processing part to perform noticing by sound;
a display effect processing part to display display data; and
a mail processing part to transmit a mail, and
the event processing part is executed with respect to the broadcast program, judged by the preference information monitoring part, to be in accord with preference information.

5. The broadcast receiving apparatus according to claim 1, wherein the broadcast data acquiring part compares the broadcast data being currently acquired with the broadcast data having already been acquired, and when it is judged that a degree of correspondence is high, switches the broadcast program for acquiring broadcast data to a broadcast program scheduled to be next in the monitoring schedule table.

6. The broadcast receiving apparatus according to claim 1, wherein a plurality of the broadcast data acquiring parts is provided.

7. The broadcast receiving apparatus according to claim 6, wherein each of the plurality of broadcast data acquiring parts acquires broadcast data of a different broadcast program in the same time period with respect to all broadcast programs, based on the monitoring schedule table.

8. The broadcast receiving apparatus according to claim 6, wherein each of the plurality of broadcast data acquiring parts acquires broadcast data of a different broadcast program in the same time period with respect to one or more than one broadcast programs differing from each other, based on the monitoring schedule table.

9. The broadcast receiving apparatus according to claim 6, wherein at least one broadcast data acquiring part in the plurality of broadcast data acquiring parts acquires broadcast data of the broadcast program, judged by the preference information monitoring part, to be in accord with preference information, and other broadcast data acquiring parts acquire broadcast data of different broadcast programs in the same time period based on the monitoring schedule table.

10. The broadcast receiving apparatus according to claim 1, wherein the broadcast data includes text data relating to a broadcast program, and the preference information monitoring part performs judgment processing, based on the text data included in the broadcast data acquired by the broadcast data acquiring part and the preference information stored in the preference information storing part.

11. The broadcast receiving apparatus according to claim 1,
wherein the broadcast data includes at least one of sound data and image data relating to a broadcast program,
the broadcast receiving apparatus further includes at least one of a sound data identifying part to identify the sound data included in the broadcast data acquired by the broadcast data acquiring part and to convert it into corresponding text data, and an image data identifying part to identify the image data included in the broadcast data acquired by the broadcast data acquiring part and to convert it into corresponding text data, and
the preference information monitoring part performs judgment processing, based on the preference information stored in the preference information storing part and at least one of the text data converted from sound data by the sound data identifying part and image data converted from image data by the image data identifying part.

12. A broadcast receiving method of a broadcast receiving apparatus that judges a broadcast program in accord with preference information comprising:
storing preference information;
storing a monitoring schedule table that indicates a monitoring schedule for each broadcast program in the same time period;
acquiring broadcast data relating to a broadcast program; and
judging whether the broadcast program being currently monitored is in accord with the preference information;
acquiring the broadcast data of the each broadcast program in the same time period, based on the monitoring schedule table stored;
comparing the broadcast data acquired with the preference information stored; and
judging whether the broadcast program indicated by a compared broadcast data accords with the preference information.
